(19) United States
(12) Patent Application Publication
(10) Pub. No.: US 2026/0280209 A1
(43) Pub. Date: Sep. 17, 2026

(54) MULTI-PURPOSE ELECTRICAL APPARATUS

(71) Applicant: Elie Waked, Strongsville, OH (US)

(72) Inventor: Elie Waked, Strongsville, OH (US)

(21) Appl. No.: 19/081,318

(22) Filed: Mar. 17, 2025

(51) Int. Cl. H01R 31/06; G08B 21/18; H01R 13/713; H01R 13/717

(52) U.S. Cl. CPC H01R 31/065; G08B 21/182; H01R 13/713; H01R 13/7175

(57) ABSTRACT

An electrical apparatus or a smart plug including a current sensor and a processor is disclosed. The current sensor may measure a real-time amount of current drawn by an appliance that may be connected to the apparatus. The processor may obtain an information associated with a user-defined ruleset. The user-defined ruleset may define a first predefined action to be performed when an amount of current drawn by the appliance exceeds a first predefined threshold, and a second predefined action to be performed when the amount of current drawn by the appliance drops below a second predefined threshold. The processor may further determine the real-time amount of current drawn by the appliance based on inputs obtained from the current sensor. The processor may additionally perform the first or second predefined action based on the real-time amount of current drawn by the appliance and the user-defined ruleset.

### TECHNICAL FIELD

The present disclosure relates to a multi-purpose electrical apparatus, and more specifically to a multi-purpose smart plug that outputs different types of alert signals based on an amount of current drawn by an appliance connected to the smart plug.

### BACKGROUND

An electrical appliance consumes electric energy drawn from a utility power source to operate. For example, an electric motor, a hair curling iron or a hair curler, a garage door opener or a garage door motor, an electric heater, and/or the like, draw current from a utility power source to operate. In many such electrical appliances, indicators (e.g., LEDs, sound buzzers, etc.) are not present that indicate the appliance's operating state. Even if the indicators are present, many-a-times such indicators do not work properly or are damaged/faulty.

In the absence of an indication of the appliance's operating state, a user may not know whether the appliance is switched ON or OFF. Such instances may cause inconvenience to the user. For example, if a curling iron is switched ON and there is no clear indication of the iron's ON state, the user may inadvertently touch the hot iron (thinking that it is in the OFF state and hence cool), leading to injury. As another example, if the garage door is yet fully open (i.e., the garage door motor is still operating) and the user attempts to drive the user's vehicle out of the garage thinking that the garage door is fully open (in the absence of any indication of the motor's running state), the user's vehicle and/or the garage door may get damaged.

Therefore, there is a need for a system that can efficiently indicate an electrical appliance's operating state to a user.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a first example usage of an electrical apparatus in accordance with the present disclosure.

FIG. 3 depicts a second example usage of an electrical apparatus in accordance with the present disclosure.

FIG. 4 depicts a flow diagram of an example method for controlling an operation of an appliance in accordance with the present disclosure.

### DETAILED DESCRIPTION

### Overview

The present disclosure describes an electrical apparatus (“apparatus”) or a smart plug that may receive electric energy from a utility power source and provide the electric energy to an external appliance for the appliance's operation. The apparatus may include a plug portion and a socket portion. The plug portion may be inserted into a utility power socket and may receive electric energy from the utility power source via the utility power socket. The socket portion may receive a plug of the external appliance, and may transfer the electric energy from the plug portion to the external appliance (to enable the appliance's operation). The external appliance may be a curling iron, a garage door opener, an electric heater, an electric motor, an industrial equipment or any other similar appliance that may require electric energy for operation. The apparatus may be a retro-fit device and not part of the external appliance. Since the apparatus is a retro-fit device, the apparatus may be connected to different types of external appliances.

The apparatus may output one or more different types of alert signals when the external appliance may be connected to the apparatus, thereby providing an indication to a user located in proximity to the apparatus about the appliance's operating state. The apparatus may output the alert signals via the apparatus's light emitting diodes (LEDs) and/or an electronic buzzer. The alert signals may provide an indication to the user when the appliance may be switched ON, switched OFF, switched OFF but still hot from its previous operation (e.g., when the appliance is a curling iron, an electric heater, etc.), or when the appliance may be inadvertently left in the ON state for more than a permissible time duration.

In some aspects, the apparatus may output the alert signals based on a user-defined ruleset, which may be customizable and defined by the user while “configuring” the apparatus for the appliance. For example, based on the user-defined ruleset, the apparatus may cause the LEDs to illuminate in a first predefined illumination pattern or the electronic buzzer to output audio in a first predefined sound pattern when the appliance may be switched ON or drawing current from the utility power source via the apparatus. In an exemplary aspect, the apparatus may include a current sensor that may measure the current that may be flowing into the appliance via the apparatus, and the apparatus may determine that the appliance may be switched ON when the current sensor detects that the current flowing through the apparatus is greater than a first predefined threshold (e.g., 1 A or 1.5 A). The LEDs' illumination and/or the buzzer's activation in the first predefined pattern, as described above, may provide an indication to users located in proximity to the appliance that the appliance is in the ON state (and hence may not be safe to touch, e.g., when the appliance is a curling iron which may be hot in the ON state).

As another example, the apparatus may cause the LEDs to illuminate in a second predefined illumination pattern or the electronic buzzer to output audio in a second predefined sound pattern when the appliance may be switched OFF or drawing no (or minimal) current from the utility power source via the apparatus. In this case, the apparatus may determine that the appliance may be switched OFF when the current sensor detects that the current flowing through the apparatus has dropped below a second predefined threshold (e.g., 0.1 A or 0.2 A). The LEDs' illumination and/or the buzzer's activation in the second predefined pattern, as described above, may provide an indication to the users that the appliance is in the OFF state.

As yet another example, the apparatus may cause the LEDs to illuminate in a third predefined illumination pattern or the electronic buzzer to output audio in a third predefined sound pattern for a predefined time duration (e.g., 5-10 minutes) after the appliance is switched OFF (e.g., when appliance is a curling iron or an electric heater). The LEDs' illumination and/or the buzzer's activation in the third predefined pattern, as described above, may provide an indication to the users that although the appliance is in the OFF state, the appliance may still be hot and hence may not be safe to touch.

As yet another example, the apparatus may automatically shut-off the supply of current to the appliance (e.g., by using a relay included in the apparatus) when the appliance is left in the ON state for more than a permissible time duration. In this case, the apparatus may alternatively or additionally cause the LEDs to illuminate in a fourth predefined illumination pattern or the electronic buzzer to output audio in a fourth predefined sound pattern, and/or transmit an alert notification to a user device associated with the apparatus user, alerting the user that the appliance should be switched OFF to avoid any potential damage to the appliance and/or the surroundings and/or present a safety hazard.

In some aspects, the first, second, third and fourth predefined illumination and/or sound patterns are substantially distinct from each other, so that the user may conveniently understand the appliance's operating state without any confusion.

The present disclosure discloses an electric apparatus or a smart plug that outputs visual and/or audible signals indicating an operating state of an external appliance that may be connected to the apparatus. By using the apparatus, the user may conveniently determine the appliance's operating state, even if the appliance itself does not have any LED or sound indicators. The apparatus further outputs signals indicating that the appliance may still be hot (e.g., when the appliance is a curling iron), even after the appliance is switched OFF, thereby preventing the user from getting hurt by the hot appliance. Furthermore, the apparatus enables the user to customize the type of alerts that the apparatus should output to indicate the appliance's operating state, thereby providing flexibility and ease of operation for the user.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

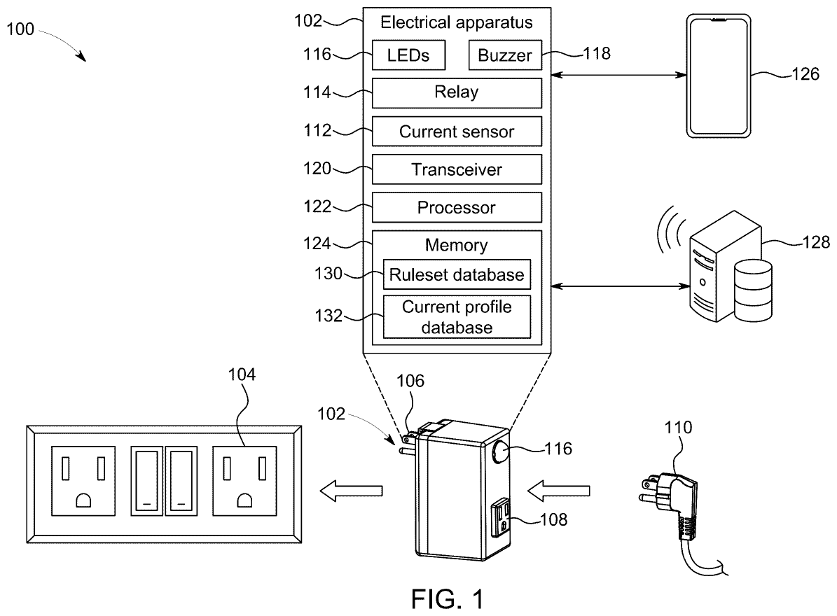

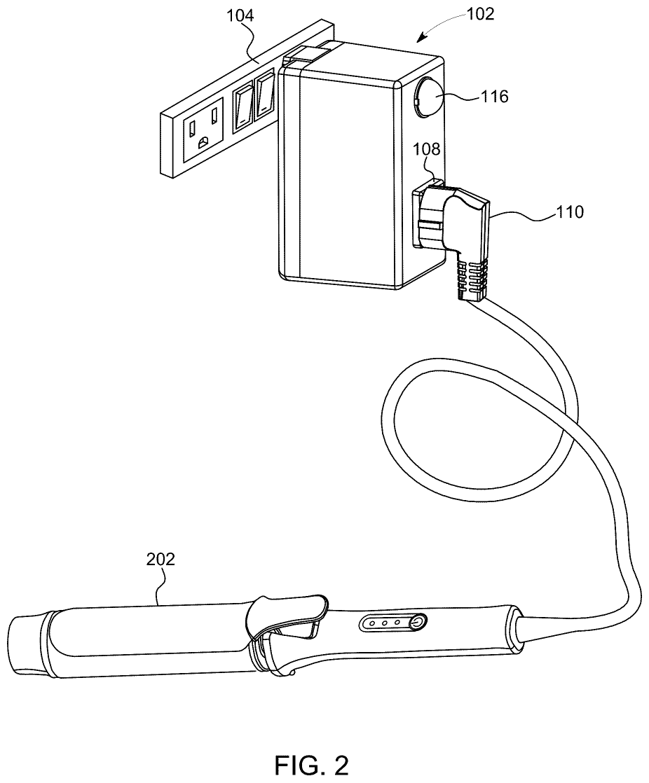

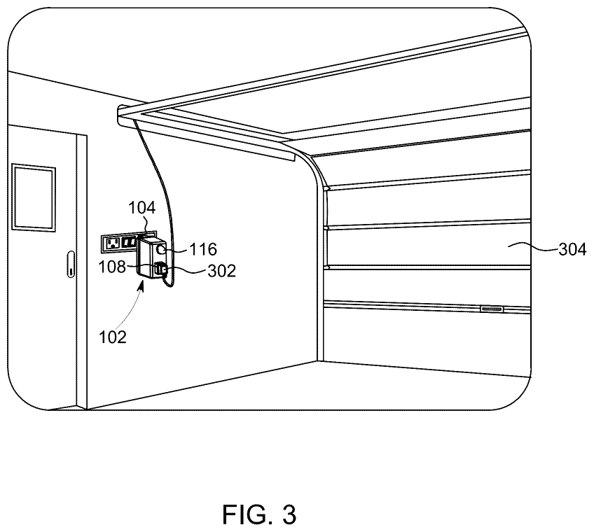

FIG. 1 depicts an example environment 100 in which techniques and structures for providing the systems and methods disclosed herein may be implemented. FIG. 1 will be described in conjunction with FIGS. 2 and 3.

The environment 100 may include an electrical apparatus 102 (or apparatus 102) that may be a smart plug configured to receive electric energy from a utility power source and provide the electric energy to an external appliance for the appliance's operation. The apparatus 102 may output one or more different types of alert signals when the external appliance may be connected to the apparatus 102, thereby providing an indication to a user (not shown) located in proximity to the apparatus 102 about the appliance's operating state.

In some aspects, the apparatus 102 may include a receptacle portion that may connect to an external appliance (e.g., a curling iron 202 shown in FIG. 2 or a garage door opener 302 shown in FIG. 3) and a utility power socket 104. The external appliance may receive current from a utility power source (not shown) via the receptacle portion and the utility power socket 104. In an exemplary aspect, the receptacle portion may include a plug portion 106 and a socket portion 108. A user may insert the plug portion 106 into the utility power socket 104 that supplies electric energy from the utility power source to the plug portion 106. Further, the socket portion 108 may receive a plug 110 of the external appliance that may be connected to the apparatus 102. The appliance may then receive electric energy from the utility power source via the plug portion 106 and the socket portion 108, when the user switches ON or activates the external appliance. In this manner, the apparatus 102 may act as a smart plug or a pass-through electrical device that transfers electric energy or current from the utility power source (obtained via the utility power socket 104) to the external appliance, to enable the external appliance's operation.

In some aspects, as shown in FIGS. 1, 2 and 3, the apparatus 102 may be a retro-fit device (or an accessory) that is not part of the external appliance. Since the apparatus 102 is a retro-fit device, the apparatus 102 can be connected to any type of external appliance, and is not restricted to operate with only a specific type of appliance. For example, the user may connect different types of electric motors, hair curling irons or hair curlers, garage door openers or garage door motors, electric heaters, fans, lights, refrigerators, industrial equipment (that may draw large amounts of current from the utility power source), and/or the like, to the apparatus 102, which may enable the flow of current from the utility power source to these appliances for their operation.

The apparatus 102 may include a plurality of components or units including, but not limited to, a current sensor 112, a relay 114, one or more light emitting diodes (LEDs) 116, a speaker or a sound exciter or an electronic buzzer 118, a transceiver 120, a microcontroller or a processor 122 and a memory 124. The current sensor 112 may measure a real-time amount of current drawn by the external appliance (that is connected to the apparatus 102 via the receptacle portion described above) from the utility power source. Stated another way, the current sensor 112 may measure a real-time amount of current that flows from the utility power source to the external appliance via the apparatus 102.

The relay 114 may control the flow of current to the external appliance via the apparatus 102, and may shut off the supply of current to the external appliance during a high voltage or current event, or based on command signals obtained from the processor 122 (as described later below).

The LEDs 116 may output light of different colors (e.g., red, green, etc.) based on command signals obtained from the processor 122. Similarly, the buzzer 118 may output audio signals or audible alerts based on command signals obtained from the processor 122.

The transceiver 120 may receive/transmit data, information, signals, etc. from/to one or more external systems and devices, via one or more networks. The network(s), as described herein, may be, for example, a communication infrastructure in which the connected devices discussed in various embodiments of this disclosure may communicate. The network(s) may be and/or include the Internet, a private network, public network or other configuration that operates using any one or more known communication protocols such as transmission control protocol/Internet protocol (TCP/IP), Bluetooth®, BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples.

Examples of the external systems and devices include, but are not limited to, a user device 126, one or more servers 128, and/or the like. In an exemplary aspect, the user device 126 may be associated with a user of the apparatus 102, and may be, for example, a mobile phone, a laptop, a computer, a tablet, a smartwatch, or any other device with communication capacities. The user may “configure” the apparatus 102 for different types of external appliances that the user may connect to the apparatus 102, via the user device 126. An example of “apparatus configuration” for an external appliance is described below.

In some aspects, when the user desires to connect an external appliance for a first time with the apparatus 102, the user may transmit information associated with a user-defined ruleset for the appliance's operation (when the external appliance is connected to the apparatus 102). The user may transmit the information to the transceiver 120 via the user device 126 and the network described above and/or via a USB. The user-defined ruleset may be customizable and may be specific to a particular appliance. Stated another way, the user-defined rulesets may be different for different appliances that may be connected to the apparatus 102.

In one exemplary aspect, the user-defined ruleset may define a first predefined action that the apparatus 102 should perform when an amount of current drawn by the external appliance exceeds a first predefined threshold. For example, the user may define in the ruleset that the apparatus 102 should illuminate the LEDs 116 in red color and/or cause the buzzer 118 to output a “beep” sound at a predefined frequency/pattern when the current drawn by the external appliance exceeds 1.5 Ampere (or any other current value based on the appliance's operating specification). In this case, whenever the external appliance is switched ON or activated while connected to utility power source via the apparatus 102, the real-time current drawn by the external appliance may be equivalent to or greater than 1.5 A. Consequently, in this case, the apparatus 102 may cause the LEDs 116 to illuminate in red color and/or the buzzer 118 to output the beep sound at the first predefined frequency/pattern whenever the external appliance is switched ON or activated. The apparatus 102 may keep the LEDs 116 and/or the buzzer 118 in their illuminated/activated states, till the current stays above (or equivalent to) 1.5 A.

In another exemplary aspect, the user-defined ruleset may define a second predefined action that the apparatus 102 should perform when the amount of current drawn by the external appliance drops below a second predefined threshold (which may be different from the first predefined threshold described above). For example, the user may define in the ruleset that the apparatus 102 should blink the LEDs 116 in green color for a short time duration and/or cause the buzzer 118 to output a termination signal (e.g., a constant beep) for the short time duration when the current drawn by the external appliance drops below 0.1 or 0.2 Ampere. In this case, when the external appliance is switched OFF or deactivated after its operation, the real-time current drawn by the external appliance may be equivalent to zero. Consequently, in this case, the apparatus 102 may cause the LEDs 116 to blink in green color for the short time duration and/or the buzzer 118 to output the termination signal when the external appliance is switched OFF or deactivated.

In yet another exemplary aspect, the user-defined ruleset may define a third predefined action that the apparatus 102 should perform for a predefined time duration (e.g., for 5-10 minutes) after the amount of current drawn by the external appliance drops below the second predefined threshold or after the external appliance is switched OFF or deactivated. For example, the user may define in the ruleset that the apparatus 102 should blink the LEDs 116 in red color for 5-10 minutes and/or cause the buzzer 118 to output a beep sound in a predefined sound pattern for 5-10 minutes after the external appliance is switched OFF or deactivated. The user may define the third predefined action when, e.g., the external appliance may be the curling iron 202 that may remain hot for 5-10 minutes even after it is switched OFF or deactivated. In this case, the apparatus 102 may cause the LEDs 116 to continue blinking in red color and/or the buzzer 118 to beep for 5-10 minutes after the appliance is switched OFF or deactivated, to alert users in proximity to the appliance that the appliance may still be hot (and hence should not be touched). Further, in this case, the apparatus 102 may cause the LEDs 116 to stop blinking and/or the buzzer 118 to stop beeping after 5-10 minutes, to indicate to the users that it may now be safe to touch the appliance/curling iron 202.

In yet another exemplary aspect, the user-defined ruleset may define a fourth predefined action that the apparatus 102 should perform when the amount of current drawn by the external appliance stays above the first predefined threshold (e.g., 1.5 A) for than a permissible time duration (e.g., 10-15 minutes) or when the external appliance stays in the ON state or activated for more than the permissible time duration. For example, the user may define in the ruleset that the apparatus 102 should transmit (via the transceiver 120) an alert notification to the user device 126 or the server 128, cause the LEDs 116 to illuminate in a predefined illumination pattern (e.g., blink at a high frequency in red color) or the buzzer 118 to output audio in a predefined sound pattern (e.g., output a loud alert signal or continuous beep sound), or automatically shut off the supply of current to the external appliance via the relay 114, when the external appliance stays in the ON state for more than 15 minutes. In this case, the apparatus 102 may perform the example action(s) described above when the appliance stays activated for more than the permissible time duration, to alert the user.

In some aspects, the permissible time duration described above may be specific to an appliance type, and the user may define the permissible time duration for the external appliance based on its type while configuring the apparatus 102. For example, it is known that personal curling irons (e.g., the curling iron 202) are generally used for a short time duration, which may not be more than 10-15 minutes. In this case, while configuring the apparatus 102 for the curling iron 202, the user may define the permissible time duration as 10-15 minutes. As another example, it is known that garage doors generally take less than 30 seconds to fully open or fully close. In this case, while configuring the apparatus 102 for the garage door opener 302, the user may define the permissible time duration as 30 seconds or 1 minute.

In other aspects, the user may not define the permissible time duration described above. Instead, in this case, the apparatus 102 may itself identify the permissible time duration of the external appliance that may be connected to the apparatus 102, by determining the appliance's type and a data structure that includes a mapping of current profiles or power signatures for a plurality of different appliance types with their respective permissible time durations. In this case, the apparatus 102 may determine the real-time current drawn by the external appliance when the appliance may be connected to the apparatus 102 for the first time. The apparatus may then correlate the real-time current value with the mapping to determine the permissible time duration for which the appliance may safely operate.

As described above, the transceiver 120 may receive the information associated with the user-defined ruleset from the user via the user device 126 and the network(s) (or via a USB). The transceiver 120 may be further configured to transmit command signals, data, information, etc. to the user device 126, the server 128, and/or the like, via the network(s).

The server 128 may provide cloud storage for the data/information that the transceiver 120 may transmit to the server 128. The server 128 further store (and transmit to the transceiver 120 when requested) the information associated with the mapping of current profiles or power signatures for a plurality of different appliance types with their respective permissible time durations. For example, the server 128 may store the information that indicates that curling irons generally operate (or draw current) for 10-15 minutes at a time, garage door openers or motors generally operate (or draw current) for 30 seconds-1 minute at a time, and/or the like.

The memory 124 may store programs in code and/or store data for performing various apparatus operations in accordance with the present disclosure. Specifically, the processor 122 may execute computer-executable instructions stored in the memory 124 for performing various apparatus functions in accordance with the disclosure. Consequently, the memory 124 may be used for storing code and/or data code and/or data for performing operations in accordance with the present disclosure.

In one or more aspects, the processor 122 may be in communication with one or more memory devices (e.g., the memory 124 and/or one or more external databases (not shown in FIG. 1)). The memory 124 may include any one or a combination of volatile memory elements (e.g., dynamic random-access memory (DRAM), synchronous dynamic random access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

The memory 124 may be one example of a non-transitory computer-readable medium and may be used to store programs in code and/or to store data for performing various operations in accordance with the present disclosure. The instructions in the memory 124 may include one or more separate programs, each of which may include an ordered listing of computer-executable instructions for implementing logical functions.

In some aspects, the memory 124 may include a plurality of databases including, but not limited to, a ruleset database 130, a current profile database 132, and/or the like. The ruleset database 130 may obtain (and store) the information associated with the user-defined ruleset described above from the user via the user device 126 and the transceiver 120. The current profile database 132 may store the information associated with the mapping of current profiles or power signatures for a plurality of different appliance types with their respective permissible time durations that the apparatus 102/transceiver 120 receives from the server 128.

The operation of the apparatus 102 is described below first in the context of an embodiment where the apparatus 102 is connected to the curling iron 202, and then described in the context of an embodiment where the apparatus 102 is connected to the garage door opener 302. The description below should not be construed as limiting the apparatus' application only to the curling iron 202 and the garage door opener 302. The apparatus 102 may operate equally efficiently in a similar manner when connected to other types of external appliances, without departing from the present disclosure scope.

When the plug 110 of the curling iron 202 is connected to (or inserted into) the socket portion 108, and the plug portion 106 is connected to (or inserted into) the utility power socket 104, the curling iron 202 may be ready to receive electric energy/current from the utility power source via the apparatus 102. When the curling iron 202 is connected to the apparatus 102 as described above, the processor 122 may obtain the information associated with the user-defined ruleset for the curling iron 202 from the memory 124/ruleset database 130. The processor 122 may further obtain inputs from the current sensor 112 to monitor/determine the real-time amount of current drawn by the curling iron 202 from the utility power source via the apparatus 102.

In an exemplary aspect, the processor 122 may not perform any operation when the inputs obtained from the current sensor 112 indicate that the curling iron 202 is not drawing any current from the utility power source (indicating that the curling iron 202 may be switched OFF or in a deactivated state). In this case, as an example, the processor 122 may keep the LEDs 116 and/or the buzzer 118 in deactivated state or switched OFF.

Further, the processor 122 may perform one or more predefined actions based on the real-time amount of current drawn by the curling iron 202 and the user-defined ruleset. In an exemplary aspect, the processor 122 may perform the first predefined action when the real-time amount of current drawn by the curling iron 202 exceeds the first predefined threshold (e.g., 1 A or 1.5 A). For example, the processor 122 may cause the LEDs 116 to illuminate in a first predefined illumination pattern (e.g., illuminate in red color) and/or the buzzer 118 to output audio in a first predefined sound pattern (e.g., output a “beep” sound at a predefined frequency/pattern) when the current drawn by the curling iron 202 exceeds 1.5 A (indicating that the curling iron 202 is switched ON or activated). The processor 122 may perform the first predefined action described here to provide an indication to users located in proximity to the curling iron 202 that the curling iron 202 is switched ON and may hence be hot. Such an indication may prevent the users from touching the curling iron 202 inadvertently, and hence prevent any adverse situation.

The processor 122 may continue to perform the first predefined action described above till the real-time amount of current drawn by the curling iron 202 stays above the first predefined threshold (or 1.5 A) to provide continuous alert indication to the users. The processor 122 may further perform the second predefined action when the real-time amount of current drawn by the curling iron 202 drops below the second predefined threshold (e.g., 0.1 A or 0.2 A). For example, the processor 122 may cause the LEDs 116 to illuminate in a second predefined illumination pattern (e.g., blink in green color for a short time duration, e.g., 2-4 seconds) and/or the buzzer 118 to output audio in a second predefined sound pattern (e.g., output a constant beep for the short time duration) when the current drawn by the curling iron 202 drops below 0.2 A (indicating that the curling iron 202 is switched OFF or deactivated). The processor 122 may perform the second predefined action described here to provide an indication to the users located in proximity to the curling iron 202 that the curling iron 202 is switched OFF.

It may be appreciated from the description above that the first predefined illumination pattern is different from the second predefined illumination pattern, and the first predefined sound pattern is different from the second predefined sound pattern, so that the users are not confused by identical alerts output via the LEDs 116 and/or the buzzer 118. Stated another way, the alerts output for the ON state of the curling iron 202 are substantially distinct from the alerts output for the OFF state of the curling iron 202, so that the users may easily understand the curling iron's operating state without any confusion.

As described above, the processor 122 may perform the second predefined action for a short time duration (or a “first predefined time duration”, which may be 2-4 seconds) when the current drawn by the curling iron 202 drops below the second predefined threshold. In some aspects, if the third predefined action is defined in the user-defined ruleset for the curling iron 202, the processor 122 may perform the third predefined action for a second predefined time duration (e.g., 5-10 minutes) after the real-time amount of current drawn by the curling iron 202 drops below the second predefined threshold or after the curling iron 202 is switched OFF (or after the processor 122 performs the second predefined action described above). For example, the processor 122 may cause the LEDs 116 to illuminate in a third predefined illumination pattern (e.g., blink in red color) for 5-10 minutes and/or the buzzer 118 to output audio in a third predefined sound pattern (e.g., output a beep) for 5-10 minutes after the current drawn by the curling iron 202 drops below 0.2 A or after the curling iron 202 is switched OFF or deactivated. The processor 122 may perform the third predefined action described here to provide an indication to the users located in proximity to the curling iron 202 that although the curling iron 202 is switched OFF, the curling iron 202 may still be hot. Such an indication may prevent the users from touching the curling iron 202 inadvertently, till the curling iron 202 cools down. The processor 122 may stop performing the third predefined action described above after 5-10 minutes (and may deactivate the LEDs 116 and/or the buzzer 118), indicating to the users that it may now be safe to touch the curling iron 202. In this manner, the apparatus 102 may prevent any adverse situation associated with the curling iron 202, even after the curling iron 202 is switched OFF.

It may be appreciated from the description above that the second predefined time duration (e.g., 5-10 minutes) is substantially greater than the first predefined time duration (e.g., 2-4 seconds). Further, the third predefined illumination pattern is different from the second predefined illumination pattern, and the third predefined sound pattern is different from the second predefined sound pattern, so that the users are not confused by identical alerts output via the LEDs 116 and/or the buzzer 118. Stated another way, the alerts that the apparatus 102 outputs when the curling iron 202 is recently switched OFF are substantially distinct from the alerts that the apparatus 102 outputs when the curling iron 202 is in the OFF state but still hot, so that the users may easily understand the curling iron's operating state/condition without any confusion.

In this manner, the apparatus 102 ensures that the users in proximity to the curling iron 202 know its state, even if the indicators on the curling iron 202 are not present or not operating optimally. Furthermore, the third predefined action described above provides an additional layer of protection/safety for the users, using which the users may know whether the curling iron 202 is still hot or is cooled down after it is switched OFF, by monitoring the LEDs/buzzer's state.

The processor 122 may perform one or more additional actions to further enhance the user's experience of operating the apparatus 102. For example, the processor 122 may perform the fourth predefined action when the real-time amount of current drawn by the curling iron 202 stays above the first predefined threshold for than the permissible time duration or if the curling iron 202 is left in the ON state for than the permissible time duration. As described above, in some aspects, the permissible time duration may be specific for the appliance type (i.e., a curling iron) and may be defined by the user for the curling iron 202 while configuring the apparatus 102 for the curling iron 202. In other aspects, the processor 122 may itself determine the permissible time duration for the curling iron 202 when the curling iron 202 may be first connected to the apparatus 102. In this case, the processor 122 may first determine the real-time current drawn by the curling iron 202 based on the inputs obtained from the current sensor 112 when the curling iron 202 may be first connected to the apparatus 102. Based on the current drawn, the processor 122 may determine the appliance type (i.e., the curling iron) and the permissible time duration for the curling iron 202 by correlating the real-time current drawn by the curling iron 202 with the mapping of current profiles or power signatures for a plurality of different appliance types with their respective permissible time durations (that may be stored in the current profile database 132, as described above).

In one exemplary aspect, the processor 122 may perform the fourth predefined action by causing the LEDs 116 to illuminate in a fourth predefined illumination pattern (e.g., blink at a high frequency in red color) and/or the buzzer 118 to output audio in a fourth predefined sound pattern (e.g., output a loud alert signal or continuous beep sound). The processor 122 may perform such action to alert the user that the curling iron 202 has been left in the ON state for more than permissible time duration and hence should be immediately switched OFF.

In another exemplary aspect, the processor 122 may perform the fourth predefined action by transmitting, via the transceiver 120, an alert notification to the user device 126 or the server 128. In yet another exemplary aspect, the processor 122 may perform the fourth predefined action by automatically shutting off the supply of current to the curling iron 202 via the relay 114, to prevent any damage to the curling iron 202 and/or the surroundings.

In a similar manner as described above, when the plug 110 of the garage door opener 302 is connected to (or inserted into) the socket portion 108, and the plug portion 106 is connected to (or inserted into) the utility power socket 104, the garage door opener 302 (and the garage door motor) may be ready to receive electric energy/current from the utility power source via the apparatus 102. In this case, the processor 122 may perform the first predefined action when the garage door motor may be operating, indicating to the user that a garage door 304 is still moving to its fully open or fully closed state. In this specific embodiment, the user may use the indications output by the apparatus 102 and not move the user's vehicle till the processor 122 is performing the first predefined action (indicating that the garage door 304 is still not fully open or closed).

Further, the processor 122 may perform the second predefined action when the garage door motor may stop operating, indicating to the user that the garage door 304 may now be in fully open or closed state. Furthermore, the processor 122 may perform the fourth predefined action when the garage door 304 may get stuck (in which case the motor may continue to draw current for more than the permissible time duration), indicating to the user that the garage door 304 may be faulty and may need repair.

In this specific embodiment, the user may not define the third predefined action in the user-defined ruleset, as the user may not require any indication after the garage door 304 is fully open or closed or after the garage door motor stops drawing current.

In additional aspects, the processor 122 may be configured to transmit periodic appliance usage reports to the server 128. Such reports may include information associated with the real-time amount of current drawn by the connected appliance over a predefined time duration (e.g., over 1 hour, 6 hours, 12 hours, 1 day, 1 week, 1 month, etc.). The server 128 may be or include Artificial Intelligence (AI) based processors that may analyze these reports over time, and provide recommendations to the user/user device 126 on optimal ways to operate the appliance. For example, if the server 128 determines (based on the analysis of usage reports) that a specific appliance “A” (e.g., an electric heater) is typically switched OFF at 5 PM every day, and on one day it kept in an ON state past 7 PM, the server 128 may transmit a notification to the user device 126 recommending the user to switch OFF the heater.

The server 128 may also provide access to such usage reports to the user device 126, so that the user may view such reports and determine the usage status of one or more appliances that may be connected to the apparatus 102.

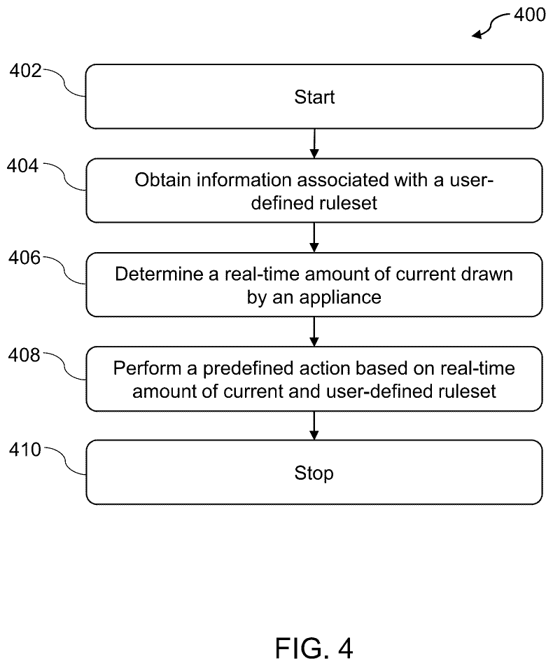

FIG. 4 depicts a flow diagram of an example method 400 for controlling an operation of an appliance in accordance with the present disclosure. FIG. 4 may be described with continued reference to prior figures. The following process is exemplary and not confined to the steps described hereafter. Moreover, alternative embodiments may include more or less steps than are shown or described herein and may include these steps in a different order than the order described in the following example embodiments.

Referring to FIG. 4, at step 402, the method 400 may commence. At step 404, the method 400 may include obtaining, by the processor 122, the information associated with the user-defined ruleset from the memory 124. At step 406, the method 400 may include determining, by the processor 122, the real-time amount of current drawn by the appliance connected to the apparatus 102 based on the inputs obtained from the current sensor 112. At step 408, the method 400 may include performing, by the processor 122, one of the first, second, third or fourth predefined actions described above based on the real-time amount of current and the user-defined ruleset.

At step 410, the method 400 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. An electrical apparatus comprising:
a current sensor configured to measure a real-time amount of current drawn by an appliance; and
a processor configured to:
obtain an information associated with a user-defined ruleset that defines:
a first predefined action to be performed when an amount of current drawn by the appliance exceeds a first predefined threshold, and
a second predefined action to be performed when the amount of current drawn by the appliance drops below a second predefined threshold;
determine the real-time amount of current drawn by the appliance based on inputs obtained from the current sensor; and
perform the first predefined action or the second predefined action based on the real-time amount of current and the user-defined ruleset.

2. The electrical apparatus of claim 1 further comprising a receptacle portion configured to connect to the appliance and a utility power socket, wherein the appliance receives current from a utility power source via the receptacle portion.

3. The electrical apparatus of claim 2, wherein the receptacle portion comprises:
a plug portion configured to be inserted into the utility power socket that supplies electric energy from the utility power source to the plug portion; and
a socket portion configured to receive a plug of the appliance, wherein the appliance receives the electric energy from the utility power source via the plug portion and the socket portion.

4. The electrical apparatus of claim 1, wherein the electrical apparatus is a retro-fit device that is not part of the appliance.

5. The electrical apparatus of claim 1 further comprising a memory configured to obtain the information associated with the user-defined ruleset from a user via a user device, wherein the processor obtains the information associated with the user-defined ruleset from the memory.

6. The electrical apparatus of claim 1 further comprising at least one of: one or more LEDs or an electronic buzzer.

7. The electrical apparatus of claim 6, wherein the processor performs the first predefined action by causing the one or more LEDs to illuminate in a first predefined illumination pattern or the electronic buzzer to output audio in a first predefined sound pattern, wherein the processor performs the second predefined action by causing the one or more LEDs to illuminate in a second predefined illumination pattern or the electronic buzzer to output audio in a second predefined sound pattern, wherein the first predefined illumination pattern is different from the second predefined illumination pattern, and wherein the first predefined sound pattern is different from the second predefined sound pattern.

8. The electrical apparatus of claim 7, wherein the processor performs the first predefined action till the real-time amount of current drawn by the appliance stays above the first predefined threshold.

9. The electrical apparatus of claim 8, wherein the processor performs the second predefined action for a first predefined time duration when the real-time amount of current drawn by the appliance drops below the second predefined threshold.

10. The electrical apparatus of claim 9, wherein the information associated with the user-defined ruleset further defines a third predefined action to be performed for a second predefined time duration after the amount of current drops below the second predefined threshold, wherein the second predefined time duration is greater than the first predefined time duration.

11. The electrical apparatus of claim 10, wherein the processor is further configured to perform the third predefined action for the second predefined time duration after the real-time amount of current drops below the second predefined threshold, wherein the processor performs the third predefined action by causing the one or more LEDs to illuminate in a third predefined illumination pattern or the electronic buzzer to output audio in a third predefined sound pattern, wherein the third predefined illumination pattern is different from the second predefined illumination pattern, and wherein the third predefined sound pattern is different from the second predefined sound pattern.

12. The electrical apparatus of claim 6, wherein the information associated with the user-defined ruleset further defines a fourth predefined action to be performed when the amount of current drawn by the appliance stays above the first predefined threshold for than a permissible time duration, and wherein the processor is further configured to perform the fourth predefined action when the real-time amount of current drawn by the appliance stays above the first predefined threshold for than the permissible time duration.

13. The electrical apparatus of claim 12, wherein the processor performs the fourth predefined action by transmitting an alert notification to a user device or a server.

14. The electrical apparatus of claim 12, wherein the processor performs the fourth predefined action by causing the one or more LEDs to illuminate in a fourth predefined illumination pattern or the electronic buzzer to output audio in a fourth predefined sound pattern.

15. The electrical apparatus of claim 12 further comprising a relay, wherein the processor performs the fourth predefined action by automatically shutting off a supply of current to the appliance via the relay.

16. The electrical apparatus of claim 12, wherein the permissible time duration is specific to an appliance type, and wherein the permissible time duration is defined by a user based on a type of the appliance.

17. The electrical apparatus of claim 12, wherein the permissible time duration is specific to an appliance type, and wherein the processor is further configured to:
determine a type of the appliance that is connected to the electrical apparatus; and
automatically determine the permissible time duration based on the type.

18. The electrical apparatus of claim 1, wherein the processor is further configured to transmit periodic appliance usage reports to a server, and wherein the periodic appliance usage reports comprise an information associated with the real-time amount of current drawn by the appliance over a predefined time duration.

19. An electrical apparatus comprising:
a current sensor configured to measure a real-time amount of current drawn by an appliance;
at least one of: one or more LEDs or an electronic buzzer; and
a processor configured to:
obtain an information associated with a user-defined ruleset that defines:
a first predefined action to be performed when an amount of current drawn by the appliance exceeds a first predefined threshold, and
a second predefined action to be performed when the amount of current drawn by the appliance drops below a second predefined threshold;
determine the real-time amount of current drawn by the appliance based on inputs obtained from the current sensor; and
perform the first predefined action or the second predefined action based on the real-time amount of current and the user-defined ruleset, wherein the processor performs the first predefined action or the second predefined action by illuminating the one or more LEDs in predefined illumination patterns or outputting audio from the electronic buzzer in predefined sound patterns, and wherein the first predefined action is different from the second predefined action.

20. An electrical apparatus comprising:
a current sensor configured to measure a real-time amount of current drawn by an appliance; and
a processor configured to:
obtain an information associated with a user-defined ruleset that defines:
a first predefined action to be performed when an amount of current drawn by the appliance exceeds a first predefined threshold,
a second predefined action to be performed when the amount of current drawn by the appliance drops below a second predefined threshold, and
a third predefined action to be performed for a predefined time duration after the amount of current drops below the second predefined threshold, wherein the first predefined action, the second predefined action and the third predefined action are different from each other;
determine the real-time amount of current drawn by the appliance based on inputs obtained from the current sensor; and
perform the first predefined action, the second predefined action or the third predefined action based on the real-time amount of current and the user-defined ruleset.
